(19) United States
(12) Patent Application Publication
(10) Pub. No.: US 2002/0160089 A1
(43) Pub. Date: Oct. 31, 2002

(54) Food patty molding apparatus with enlarged fill area

(76) Inventor: Gary Cowart, McDonough, GA (US)

Correspondence Address: David J. Meyer, MANATT, PHELPS & PHILLIPS, 11355 West Olympic Boulevard, Los Angeles, CA, 90064, US

(21) Appl. No.: 10/183,279

(22) Filed: Jun. 26, 2002

Related U.S. Application Data
(63) Continuation-in-part of application No. 09/561,120, filed on Apr. 28, 2000.
(63) Continuation-in-part of application No. 09/650,343, filed on Aug. 28, 2000.
(63) Continuation-in-part of application No. 10/152,294, filed on May 20, 2002.

(51) Int. Cl. A01J 1/00

(52) U.S. Cl. 426/512

(57) ABSTRACT

A modified food patty molding machine to increase the available fill area for forming food patties. In the preferred embodiment, the fill area is increased by extending the stroke length by about 4 inches, and increasing the dimension of the mold plate and greater versatility in the food patties that may be formed, as well as increasing the capacity as compared with stock machines

This application is a continuation-in-part of U.S. patent application Ser. No. 09/561,120, filed Apr. 28, 2000, Ser. No. 09/650,343 filed Aug. 28, 2000, and Ser. No. 10/152,294 filed May 20, 2002.

The apparatus of the present invention substantially increases the fill area of existing equipment. Indeed, one of the principal advantages of the invention is that it may be implemented on existing equipment with a relatively modest change in tooling. In preferred embodiments of the invention, 10 quarter pound food patties are prepared in the course of a single machine cycle. A further advantage of the invention is that it enables preparation of large food patties of differing shapes and sizes. Embodiments of the invention are capable of providing significantly increased output of food patties at reduced operating speeds, and with higher yields.

### BACKGROUND OF THE INVENTION

Food patties are used in a variety of different food products. Ground meat patties are used in particularly high volume by fast food restaurants. In view of the high demand for food patties of various types, increasing the rate at which food patties are produced, without incurring the cost of new equipment is an objective of the food processing industry. A further objective is to improve the rate of production of food patties without incurring the cost of new equipment. These objectives are met by the invention disclosed and claimed herein.

In existing high speed production equipment, ground food material is extruded under pressure through a single continuous slot that spans nearly the entire mold plate. In such machines, typically five to six patty cavities are filled simultaneously in the course of each machine cycle. The productivity of existing food processing equipment is therefore limited.

A number of inventions have attempted to address the deficiencies of prior art equipment used for food patty preparation. For example, Holly, U.S. Pat. Nos. 3,747,160, 3,750,232 and 3,765,056 refers to food patty molding apparatus including a sliding plate comprising mold openings. However, the machines are generally small, and incapable of high speed production of food patties.

Sandberg et al., U.S. Pat. Nos. 4,054,967; 4,356,595 and 4,821,376 refers to large high speed machines for production of food patties but does not teach or suggest improvements in the rate at which food patties may be formed. Richards, U.S. Pat. No. 3,887,964 refers broadly to modification of a mold plate, but fails to make any suggestions of what modifications may be made.

In general, prior art patty forming equipment employs a fill plate through which food material is extruded. For example Richards, U.S. Pat. No. 3,887,964, a representative example of prior art machines, refers to a single fill slot for extruding food material into patty forming cavities in a mold plate. A drawback of single slot fill plates is that food is pumped into areas of the mold plate between patty cavities. The present invention therefore represents an improvement on the prior art in using a discontinuous fill slot, in which openings in the fill plate correspond to patty cavities in the mold plate. More importantly, the present invention substantially increases the output of food patties by providing an enlarged area for food molding, compatible with stock patty forming machines, that increases the output of food patties, while affording substantial flexibility in the size and variety of the food patties that may be formed formed.

### SUMMARY OF THE INVENTION

The present invention overcomes the above mentioned deficiencies of the prior art. The invention relates to an improved apparatus for making food patties, such as hamburgers, as well as patties made from other sources of ground meat, such as pork and chicken and ground vegetable products. The invention includes improvements in tooling used with existing food processing equipment that allows a single machine to provide a greater variety of food patties to be formed, while producing food patties at a greater rate than prior art machines. These improvements are provided by relatively inexpensive modification of existing equipment.

More specifically, the present invention relates to a food molding apparatus with an enlarged fill area, comprising plural rows of cavities for forming food patties, a fill plate for use in conjunction with the mold plate to extrude food material into cavities of the mold plate, and a breather plate to exhaust gas trapped during extrusion, without deforming the food patties. The enlargement in fill area is effected by extending the stroke length by about four inches, and lengthening the shorter dimension of the mold plate by about two inches. The invention includes other modifications to stock patty forming machines, discussed below in detail.

In preferred embodiments of the invention, food material is extruded by way of a fill plate into patty cavities formed in a mold plate. In one embodiment, the mold plate comprises two rows of five patty cavities. The mold plate reciprocates between loading and discharge positions so that in a presently preferred embodiment, each cycle of the food patty molding machine yields an increased number of food patties, as compared with comparable stock machines such as those embodying the Richards '964 patent.

In operation, the mold plate reciprocates between the fill plate, below, and breather plate above. The contacting surfaces of the respective surfaces are, accordingly smoothed to minimize friction. The dimensions of the mold plate and drive train are modified to accommodate an increase in stroke length of about four inches.

Thus the invention provides a substantial increase in fill area, as well as an increased output of food patties, while also providing greater flexibility in the shape of food patties that may be formed, with relatively minor modification of existing equipment.

### BRIEF DESCRIPTION OF THE DRAWINGS

FIG. 1 is a schematic drawing, of the food molding apparatus according to the invention, from the side.

FIG. 2(a) compares the stock mold cover (left) with the mold cover modified according to the invention (right). FIG. 2(b) provides a similar comparison of exploded views of the stock food molding apparatus (left) and as modified according to the invention (right).

FIG. 3 is a composite drawing of the preferred breather plate, mold plate and fill plate, in sequence.

FIG. 4 is an enlarged drawing of the mold plate.

FIG. 5 is an enlarged drawing of the mold plate superimposed on the fill plate to show the relationship between the fill slots and patty cavities.

FIG. 6 shows the breather plate, mold plate and fill plate superimposed to show the relationships between the breather plate and patty cavities.

FIG. 7 shows an embodiment of the reciprocating assembly of the invention.

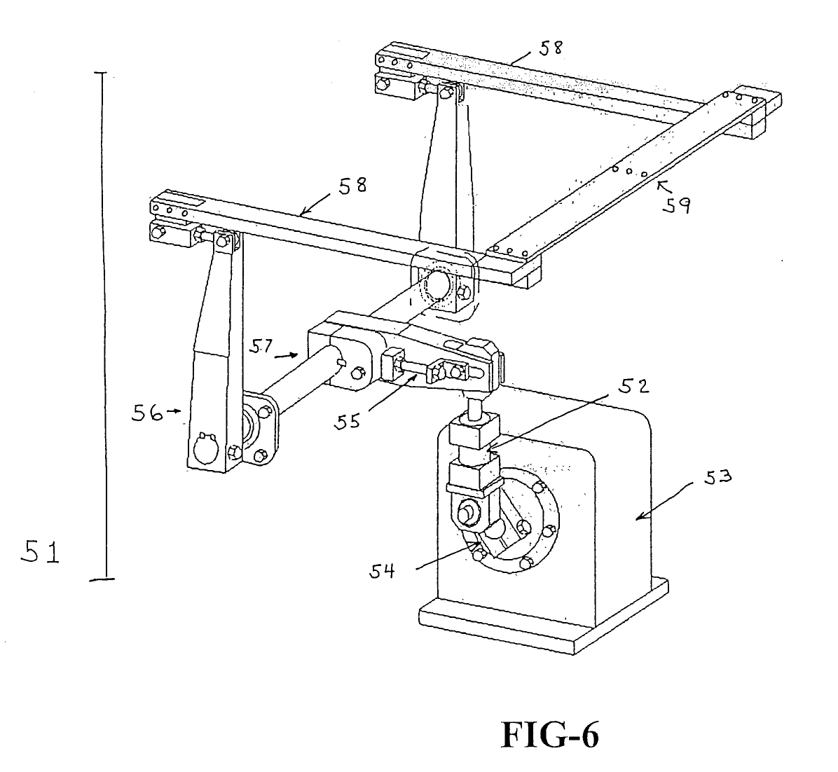

Table 1 is a summary of the timing and hydraulic pressure changes relative to the position of the mold plate in presently preferred embodiments of the invention.

### DETAILED DESCRIPTION OF THE INVENTION

In one aspect, the invention relates to improvements in equipment for forming food patties. More specifically, the improvement relates to modifications to the mold plate, fill plate, top plate and breather plates, as well as to the mold cover, shuttle arms and the drive train of the food patty molding apparatus. In preferred embodiments the food patty molding equipment is a Formax 26 machine, manufactured by Formax, Inc. of Mokena Ill., modified in accordance with the invention disclosed and claimed herein.

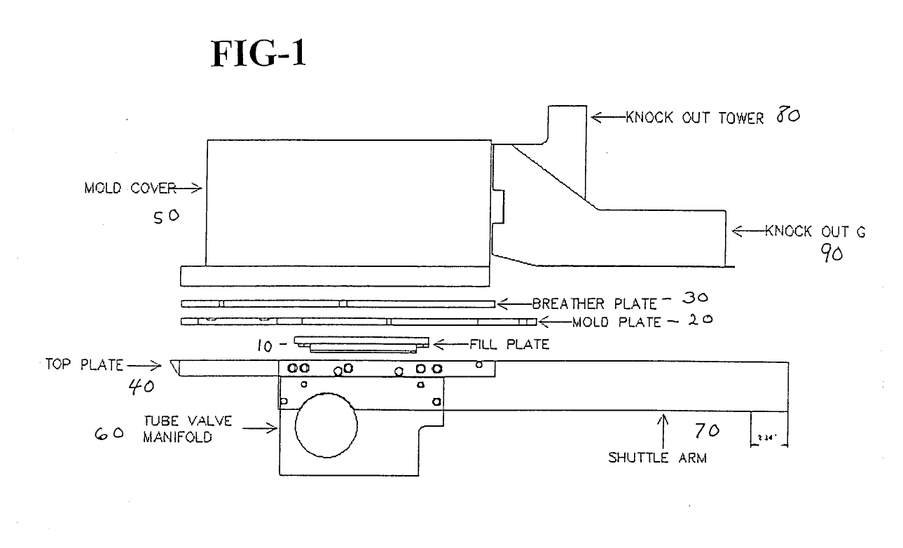

A section view of a food molding apparatus embodying the invention is shown in FIG. 1. Fill plate 10, mold plate 20 and breather plate 30 are shown located between top plate 40 and mold cover 50. In addition, tube valve manifold 60 and shuttle arm 70 are shown illustrated. Knock out tower 80 and knock out guard 90 are shown in the upper portion of FIG. 1. The fill plate, mold plate and breather plate of the invention are illustrated, in an exploded view, located between the mold cover and top plate. Top plate 40 supports shuttle arm 70.

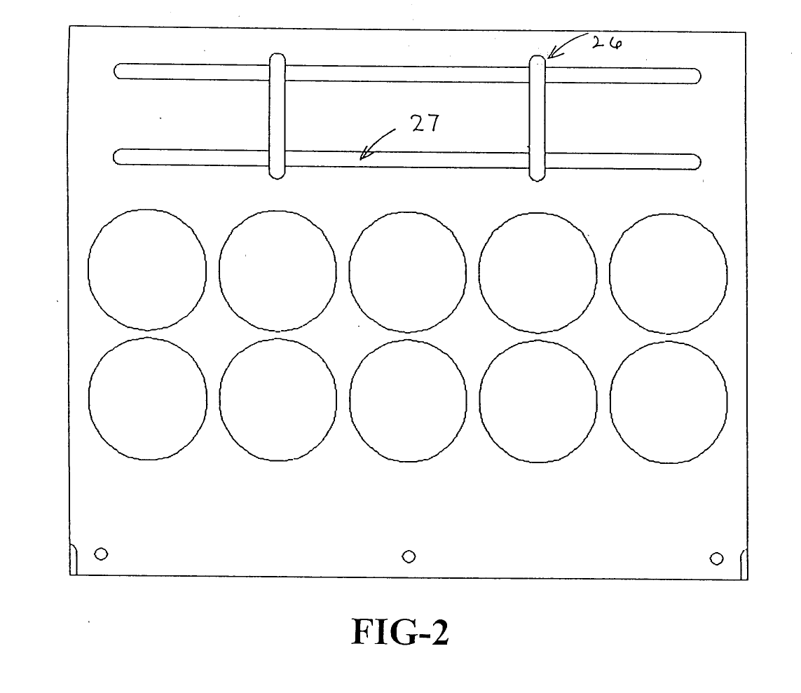

A detailed schematic drawing of a portion of an embodiment of a food molding apparatus according to the invention is shown in FIG. 2. Fill plate 10, mold plate 20 and breather plate 30 are shown separated for clarity of illustration. In operation, the fill, mold and breather plates form a stack (shown in FIG. 1) in which the food patties are formed, which is sealed against atmosphere. The difference in the dimensions (2.34 inches of the fill, mold and breather plates of the invention of Ser. No. 10/152294 is illustrated in FIG. 2A.

It should of course be born in mind that other arrangements, such as inverting the order in which the plates are arranged, is also within the scope of the invention. In the preferred embodiment, a mold cover is positioned atop breather plate 30.

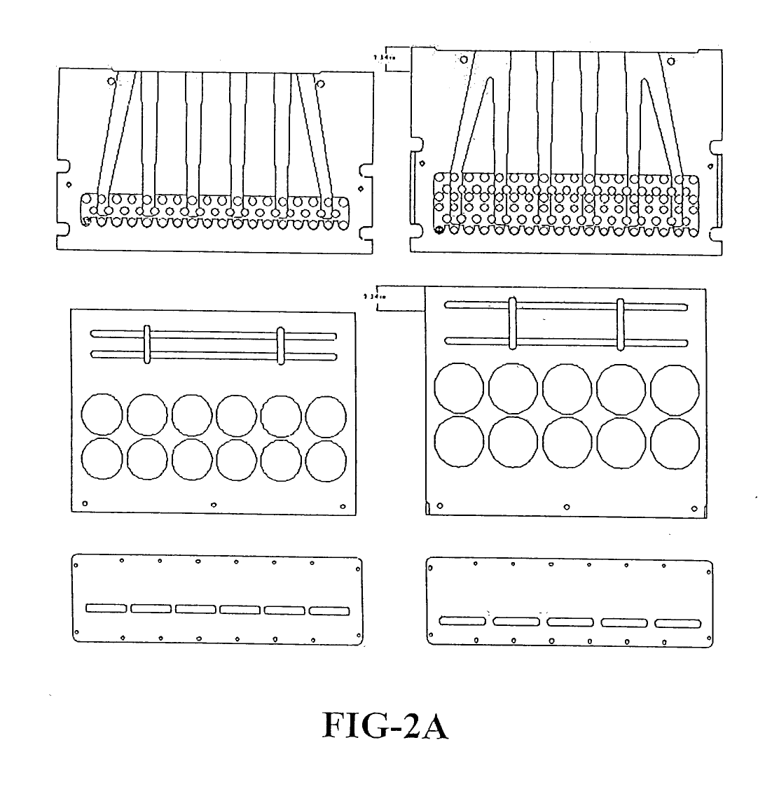

Preferably, fill plate 10 is formed of stainless steel, as are other components of the inventive apparatus, and is generally rectangular. As shown in FIG. 3, fill plate 10 is formed with rectangular slots (15) milled through it. In a preferred embodiment, the slots 15 may have rounded edges. In the presently preferred embodiment, the fill plate has five slots, aligned with one another, across the long dimension of the fill plate, though more or fewer slots and arrangements thereof, are within the scope of the invention. In one embodiment of the invention, the fill slots are oriented at an acute angle with respect to the surface of the fill plate. In the presently preferred embodiment, the fill slots are oriented perpendicularly to the surface of the fill plate.

Mold plate 20 is rectangular in shape, though wider than fill plate 10. As shown in FIG. 2, mold plate 20 has two rows of generally circular conventional patty cavities. Because of the additional fill area provided by preferred embodiments of the invention, more than one row of food patties can be formed in the course of a single machine cycle. The number of rows of patty cavities will depend on, for example, the dimensions of the food patties formed. Thus two rows of quarter pound food patties, such as hamburgers can be formed, while a larger number of smaller tenth pound hamburgers may be formed in the course of a single machine cycle. Other sizes and shapes of food patties, as well as other arrangements of patty cavities may be determined by those ordinarily skilled in the art.

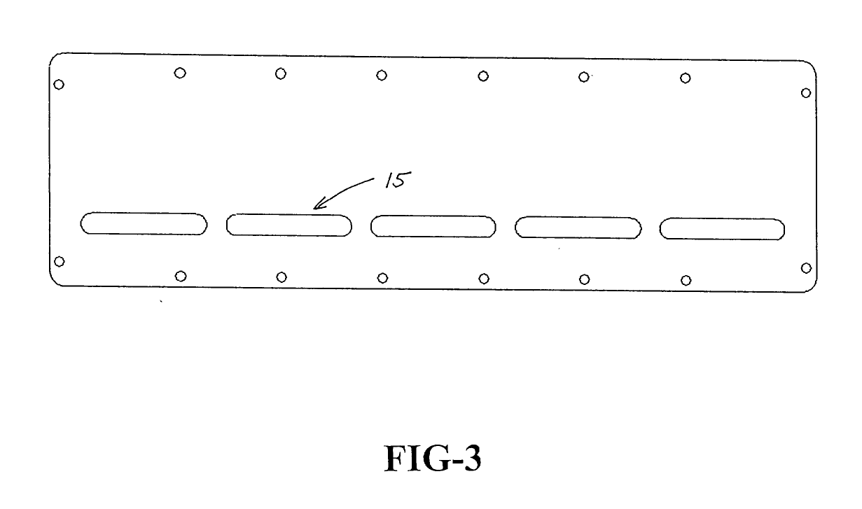

The openings of each of the fill slots of fill plate 10 aligned with the openings of the patty cavities as shown in FIG. 4. As will be described in greater detail below, the mold plate reciprocates between fill and discharge positions. At the same time, two rows of patty cavities are sequentially filled with food material as the mold plate moves over the openings of the fill slots.

As shown in FIG. 2, in preferred embodiments, lubrication slots (26) oriented parallel to the shorter dimension of the mold plate are milled through the mold plate behind the rows of patty cavities. Food material such as ground meat provides continuous lubrication of the moving metal parts during operation of the patty forming apparatus; the excess food product is removed by way of the lubrication slots. In preferred embodiments, channels (27) are also formed in the upper surface of the mold plate to provide lubrication.

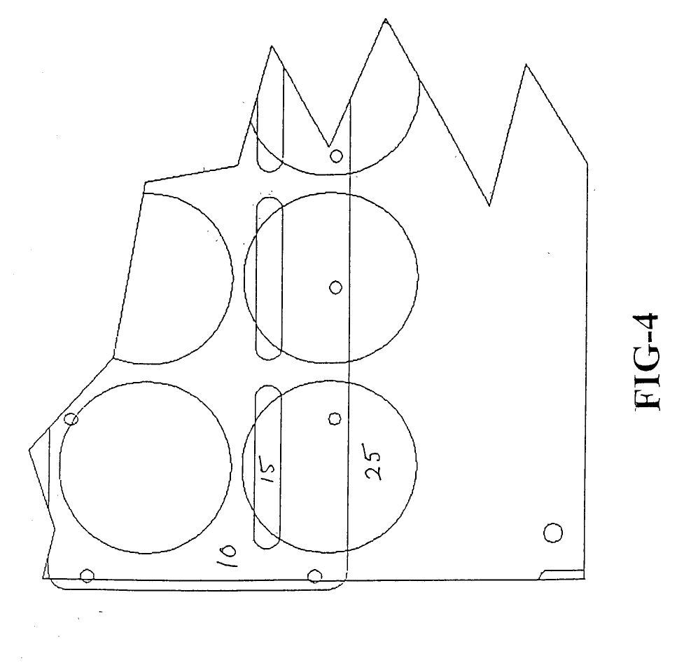

A breather plate 30 is positioned atop the mold plate. The breather plate has openings—preferably perforations (36 in FIG. 5)—formed in its upper surface to exhaust gases formed by the operation of the patty forming apparatus. In preferred embodiments, the surface of the breather plate is formed with channels milled in its surface to direct excess food material away from the patty and back to the food pump apparatus. FIG. 5 illustrates the fill plate (10), mold plate (20) and breather plate 30 in phantom, to depict their spatial relationship to one another in the inventive apparatus.

The increase in the fill area effected by the present invention is provided by increasing the extent of the shorter dimension of the mold plate—and other parts identified below—by about two inches. In the most preferred embodiment of the invention implemented on a Formax 26 machine, the shorter dimension of mold plate (20) is extended by 2.3404 inches. The dimensions of the most preferred embodiment are affected by the dimensions of other components of the food patty forming machine, principally the anti lip bar. Thus, the optimal dimensions will be affected by the design of other components, the determination of which will be within the grasp of those ordinarily skilled in the art.

Since the longer dimension of the mold plate is 26 inches, the net increase in useable fill area for the most preferred embodiment of the invention is approximately 61 square inches. Because the fill area of the stock machine is 2.3404 square inches, the invention provides an increase of 25% the available fill area, with a modest change in tooling.

In addition to increasing the size of the mold plate, the length of the top plate 40, the shorter dimension (when viewed from the front) of mold cover 50, draw bar 59 and shuttle arms 70 is also extended by 2.3404 inches. Crank arm (59) is extended by ⅛ inch and shuttle bearings are extended by 1 inch in the most preferred embodiment.

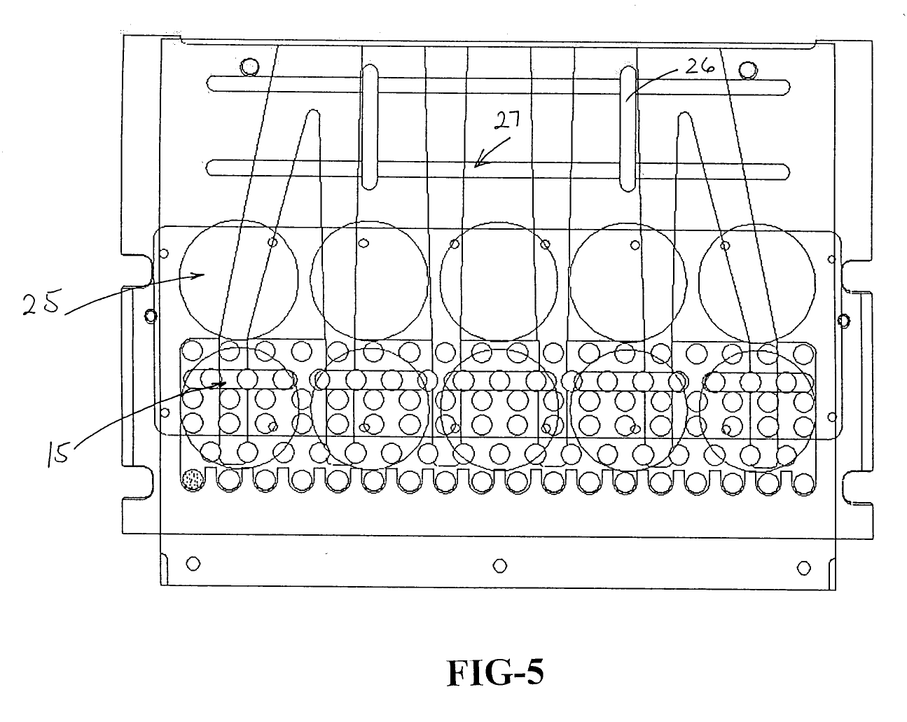

In operation, equipment modified in accord with the present invention to form food patties employs plungers operated by hydraulic cylinders and piston assemblies to extrude food material from slots in fill plate (10) through application of hydraulic pressure. A mold plate is moved back and forth in a horizontal plane between fill and discharge positions by a reciprocating assembly. The reciprocating assembly is described below with reference to FIG. 6.

In one embodiment the reciprocating assembly (51) includes a gear box (53), which rotates a crank arm (54). An embodiment of reciprocating assembly is shown in FIG. 5. The rotation of the crank arm results in linear displacement of a connector rod, 52. The connector rod is attached to a short arm (55) which is in turn attached to a rocker arm drive shaft (57). In preferred embodiments, the adjustable length of short arm (55) is extended over that of the stock machine to accommodate the greater extent of mold plate (20). Linear movement of the connector rod causes the short rocker arm to pivot about the axis of the rocker arm drive shaft. The rocker arm drive shaft is in turn attached to a pair of mold plate drive arms (58). Rotation of the short arm about the axis of the rocker arm drive shaft causes the rocker arms (56) to reciprocate back and forth in a horizontal plane. A draw bar (59) facilitates attachment of the mold plate to the mold plate drive arms.

In a presently preferred embodiment the mold plate reciprocates between fill and discharge positions at about 65 cycles per minute. This rate can be varied however, using techniques well known in the food processing art. In a presently preferred embodiment, the mold plate reciprocates at approximately 80 cycles per minute, though greater rates of production are possible.

Also in a preferred embodiment of the invention, a smaller hydraulic cylinder is employed to move the plungers used to extrude food material, in order to achieve faster filling of the patty cavities. More specifically, the four inch hydraulic cylinders are preferably replaced by 3¼ inch cylinders.

In operation, fill plate 10 receives food material such as ground beef, under hydraulic pressure in excess of up to 400 psi from a food pump (not shown) which may be located beneath the fill plate. The food material thereafter enters patty cavities (25) through fill slots (15) in the fill plate. Continued application of hydraulic pressure forces food material into patty cavities (25) in the mold plate, while the mold plate is in a filling position.

The mold plate reciprocates between filling and discharge positions. In contrast to prior art patty forming machines, and as described in more detail below, multiple rows of food patties are formed in the course of each machine cycle. As already mentioned, prior art patty forming machines typically form a single row of patties in each machine cycle. Providing one or more additional rows of patty cavities in the mold plate increases the capacity of the machine, with minimal machining. Thus a further advantage of the invention is that food patties may be produced at a greater rates as compared with conventional equipment. Prior art high food patty forming equipment, such as the above-mentioned Formax machines, produce five to six patties each machine cycle.

The patty cavities are sealed against the atmosphere during the patty forming process. Preferably the lubrication grooves in the mold plate are relocated by one half inch toward the rear of the machine. Preferably, the mill slots are removed in their entirety.

When the mold plate is in the discharge position, knock out cups activated by a cam mechanism descend from above the mold plate to push the formed food patties out of the mold plate and onto, for example, a conveyor belt. Because the food patty forming machine in accordance with the present invention forms multiple rows of food patties at once, the knockout bar and associated knock out cups are modified to dislodge food patties from all rows at once. Thus in the presently preferred embodiment, multiple rows of knock out cups are activated at once in order to dislodge both rows of patties formed in a single machine cycle.

In order to increase the fill area of the mold plate, as described herein, the stroke length is increased by about 4 inches. Obviously, the fill area may be increased by more or less through use of different dimensions, or combinations without departing from the invention set forth herein. Extension of the stroke length is required because multiple rows of patty cavities are filled from a single row fill slots. The change in stroke length also requires modification of the drive train used for moving the mold plate during the molding cycle. In particular the length of short arm adjustment slot is increased so that the rear adjustment slot may be positioned one half-inch closer to the rear of the machine. It should be noted that an adjustment slot either not present or not long enough in all food processing machines. In machines lacking the facility for such adjustment, arrow 55 in FIG. 5 indicates the location of an adjustment slot that should be created in the short arm to effectuate this aspect of the invention.

The position of the of the mold plate, and its relationship to the mechanical stroke provided by reciprocating assembly (51) as well as the hydraulic pressure applied to the ram used to extrude food material into the mold and fill plates of the present invention is summarized in Table 1, with the progress of a machine cycle defined in terms of the degrees of offset from top dead center of the crank arm of the reciprocating assembly (51). The timing of stock machines must be modified because two rows of patty cavities are filled an emptied during each machine cycle, as compared with stock machines, in which only one row of patty cavities is filled and emptied per cycle.

At the beginning of a machine cycle, with the mold plate in the discharge position (0 degrees stroke), the mold plate is stopped (“dwell”). Low pressure is applied to the ram. At 56 degrees of stroke, the mold plate is moved backward by a pair of draw a bars under the control of reciprocating assembly (51). At 120 degrees, high pressure is turned on, extruding food material into the patty cavities, and the rear mold plate cavities begin to fill, as the rear patty cavities are drawn across fill plate (10). High pressure remains on at 171 degrees of stroke, as the mold plate is again stopped in dwell, and the front cavities begin to fill. At 220 degrees the both sets of patty cavities stop filling, and the mold plate begins to move toward the discharge position, at the front of the machine. High pressure is shut off as filling of the patty cavities is complete. At 350 degrees, the mold plate stops in dwell, in the discharge position. At 354 degrees, high pressure remains off, and the knock out cups are activated to dislodge the patties formed during the machine cycle.

The invention has been described in terms of certain preferred embodiments. However, the scope of the invention defined not by embodiments used for purposes of illustration, but by the claims appended hereto.

I claim:

1. An improved food patty molding apparatus capable of forming 10 quarter pound ground meat patties in each machine, comprising a fill plate with 5 fill slots therein.

2. The improved food patty molding apparatus comprising a mold plate in which a plurality of rows of patty cavities are formed, wherein each row of patty cavities is oriented parallel to the long axis of the mold plate.

3. The improved food patty molding apparatus of claim 2, wherein the fill plate replaces a fill plate comprising a single fill slot.

4. The improved food patty molding apparatus of claim 2, comprising two rows of patty cavities.

5. The improved food patty molding apparatus of claim 2, comprising a plurality of rows of patty cavities.

6. The improved food patty molding apparatus of claim 1, further comprising a fill plate that is extended by about two inches from its fill discharge end to its fill end.

7. The improved food patty molding apparatus of claim 1, wherein a separate set of knockout cups dislodge food patties from each row of patty cavities.

8. The improved food patty molding apparatus of claim 1, wherein the stroke length is increased by about 4 inches.
